(19) United States
(12) Patent Application Publication
(10) Pub. No.: US 2022/0274683 A1
(43) Pub. Date: Sep. 1, 2022

(54) PRESSURE BULKHEAD

(71) Applicant: CITD ENGINEERING & TECHNOLOGIES SL, GETAFE- MADRID (ES)

(72) Inventors: Cristina MAESTRE GONZALEZ, GETAFE- MADRID (ES); Marta GARCIA-COSIO CARMENA, GETAFE- MADRID (ES)

(21) Appl. No.: 17/628,802

(22) PCT Filed: Mar. 17, 2020
(86) PCT No.: PCT/ES2020/070184

§ 371 Date: Jan. 20, 2022

(30) Foreign Application Priority Data
Jul. 24, 2019 (ES) U 201931273

(51) Int. Cl. B64C 1/10; B64C 1/00

(52) U.S. Cl. CPC B64C 1/10; B64C 1/00; B64C 2001/0072

(57) ABSTRACT

A pressure bulkhead having a laminate body made of composite material with a polymer matrix reinforced with fibers in a laminate arrangement; a general bulging of the laminate body, which extends along a face thereof; concave reliefs and convex reliefs alternately arranged on the laminate body, defining stiffer areas of change from convexity to concavity that act as stiffeners, the concave reliefs and convex reliefs having a maximum angular width of 180 degrees to prevent negatives in the production mould and to facilitate demoulding; and a rigid interface embedded in the laminate body, for securing the bulkhead, and for securing to the aircraft structure.

### OBJECT OF THE INVENTION

The present invention refers to a bulkhead for separating areas at different pressures, a very common use case in aircraft.

### BACKGROUND OF THE INVENTION

Space launch vehicles have several pressure membranes which separate the environment of the launch vehicle from the environment of the satellite with requirements for cleaning the dust from the propulsion of the launch vehicle in optical instruments of the satellite. In commercial aircraft, there are several walls or bulkheads subject to differential pressures, due to the effect it has on both sides thereof. The best shape for these bulkheads, in terms of architecture and space optimisation, is a flat surface, but the stiffness and strength capacity of flat shapes are not good enough, needing to be reinforced in order to meet the requirements and specifications. Making them with a concave geometry in order to better withstand pressure and using reinforcements is the general solution today. However, this trend implies an increase in mass and volume.

This drawback is solved with the bulkhead of the invention.

### DESCRIPTION OF THE INVENTION

The pressure bulkhead of the invention has an essentially laminar configuration, achieving high strength in combination with a low weight and a very small volume, which makes it ideal for use as a pressure bulkhead, being able to withstand considerable pressure differentials on both sides.

According to the invention, the pressure bulkhead comprises:
A laminate body, made of composite material with a polymer matrix with fibre reinforcement in a laminate arrangement (in other words, wherein the fibre layers follow the general laminar arrangement of the body),
A general bulging of the laminate body (that is, encompassing most of the laminate body in order to give it a domed or cupula shape which improves the strength against loads due to higher pressures on the convex portion thereof), which extends along a face thereof,
Concave reliefs and convex reliefs alternately arranged on the laminate body, conferring stiffer areas with the changes from convexity to concavity that act as stiffeners,
The concave reliefs and convex reliefs having a maximum angular width of 180 degrees to prevent negatives in the production mould and to facilitate demoulding; and
A rigid interface embedded in the laminate body for securing the bulkhead, provided with means for securing to the aircraft structure.

With this design it is possible, on the one hand, to create a bulkhead that incorporates stiffening areas in its own structure without needing additional ribs, and on the other hand, to provide a suitable geometry for the selected production method. By being globally concave (or convex depending on from where it is observed), this configuration is stiffer than something flat for a pressure differential. While on said base geometry (which is bulged) the concave-convex alternation creates the stiffening areas in the form of built-in ribs, the absence of negatives (areas which do not have the same demoulding direction as the rest) greatly facilitates production by means of female tooling. The geometric optimisation makes it possible to save on mass and improve the volume of the part, such that, for example for civil uses, it can enable an additional row of seats to be incorporated, with the consequent savings and benefits for companies in the aeronautical sector.

Moreover, costs are further reduced thanks to economies of scale, due to the number of parts to be manufactured per year. Actually, it is being laminated, and this process must be industrialised by means of infusion, pressurised production, etc.

The improvement provided by this concept of a pressure bulkhead is considerable. Saving on weight is critical for any aircraft, this being closely related to the fuel savings and load capacity. Additionally, the increase in the free volume in the aircraft improves accessibility and affects the load capacity. Both are key improvements in the aeronautical sector, positively impacting sustainability and the interaction thereof with the environment.

### BRIEF DESCRIPTION OF THE DRAWINGS

FIG. 1 shows a perspective view of the pressure bulkhead of the invention.

FIG. 2 shows a front view of the pressure bulkhead of the invention.

FIG. 3 shows a side view of the pressure bulkhead of the invention.

### DESCRIPTION OF A PRACTICAL EMBODIMENT OF THE INVENTION

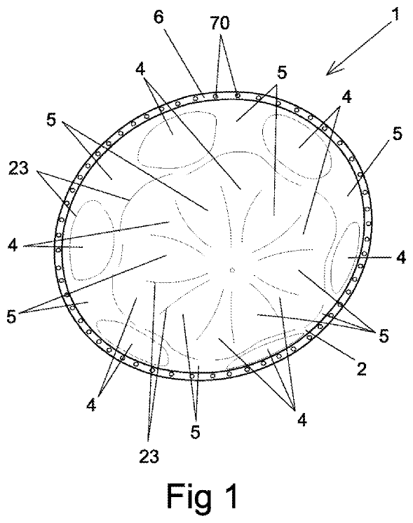

The pressure bulkhead (1) of the invention comprises:
A laminate body (2) made of composite material with a polymer matrix reinforced with continuous fibres in a laminate arrangement,
A general bulging (3) (see FIG. 3) of the laminate body (2), which extends along a face (22) thereof,
Concave reliefs (4) and convex reliefs (5) alternately arranged on the laminate body (2) (see FIG. 1), defining stiffer areas (23) of change from convexity to concavity acting as stiffeners (said areas are represented in the figures with thin lines, but they are not really physical edges, they are marked only for a better understanding of the invention),
The concave reliefs (4) and convex reliefs (5) having a maximum angular width of 180 degrees to prevent negatives in the production mould and to facilitate demoulding; and
A rigid interface (6) embedded in the laminate body (2), for securing the bulkhead, and provided with means for securing to the aircraft structure (in this example of the invention the holes (70) would be for the passage of screws which are not shown).

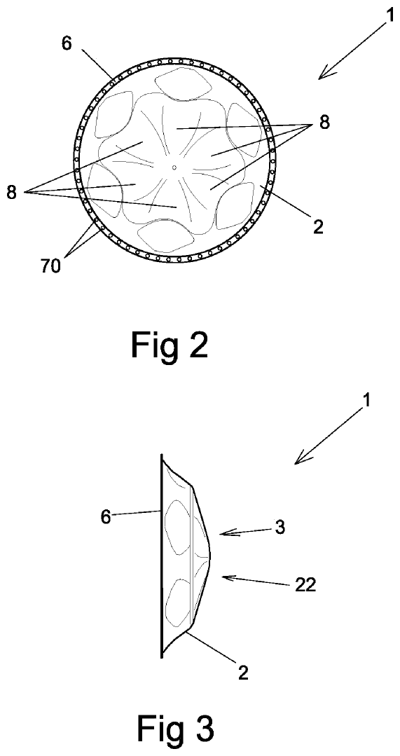

Preferably, the concave reliefs (4) and the convex reliefs (5) alternately placed have an arrangement inspired by biostructural shapes; in other words, a strong shape similar to those implemented by living beings in the laminar portions thereof and which have a strength demonstrated and improved by evolution itself (for example, radial shapes such as flower petals, polygonal shapes such as honeycombs, etc.). In this preferred example, the arrangement in the shape of a biostructure comprises a radial configuration in the shape of flower petals (8) (see FIG. 2), which radiates from the geometric centre growing in radius, which makes it possible to meet all the strength requirements without additional reinforcements.

Regarding the nature and composition of the raw materials thereof, the laminate will be made up of a matrix based on thermosetting polymer resin, preferably vinyl ester, while the fibres could be any material (carbon, glass or aramid).

Having sufficiently described the nature of the invention, in addition to the manner of applying it in practice, it must hereby be stated that the aforementioned arrangements indicated and represented in the attached drawings are susceptible to modifications with regard to the detail provided that they do not alter the fundamental principle of the invention.

1. A pressure bulkhead comprising:
a laminate body made of composite material with a polymer matrix reinforced with fibers in a laminate arrangement;
a general bulging of the laminate body, which extends along a face thereof
concave reliefs and convex reliefs alternately arranged on the laminate body, defining stiffer areas of change from convexity to concavity that act as stiffeners,
the concave reliefs and convex reliefs having a maximum angular width of 180 degrees to prevent negatives in the production mould and to facilitate demoulding; and
a rigid interface embedded in the laminate body, for securing the bulkhead, and provided with means for securing to the aircraft structure.

2. The pressure bulkhead according to claim 1, wherein the concave reliefs and the convex reliefs alternately placed have an arrangement inspired by biostructural shapes.

3. The pressure bulkhead according to claim 2, wherein the arrangement in a biostructural shape comprises a radial configuration in the shape of petals.

4. The pressure bulkhead according to claim 1, wherein the polymer matrix is made of polymer resin.

5. The pressure bulkhead according to claim 1, wherein the fibers are selected from the group consisting of carbon fiber, fiberglass and aramid fiber.

6. The pressure bulkhead according to claim 5, wherein the laminate body is made of carbon fiber with a vinyl ester matrix.
